(19) United States
(12) Patent Application Publication
(10) Pub. No.: US 2015/0120387 A1
(43) Pub. Date: Apr. 30, 2015

(54) Systems and Methods for Demand-Based Marketplaces

(71) Applicant: Wantboards, Inc., Anaheim, CA (US)

(72) Inventors: Rudy Marilla, Anaheim, CA (US); Ray Hahn, Anaheim, CA (US)

(73) Assignee: Wantboards, Inc.

(21) Appl. No.: 14/516,374

(22) Filed: Oct. 16, 2014

Related U.S. Application Data
(60) Provisional application No. 61/896,428, filed on Oct. 28, 2013.

(51) Int. Cl. G06Q 30/02; G06Q 20/24

(52) U.S. Cl. CPC G06Q 30/0202; G06Q 20/24
USPC 705/7.31

(57) ABSTRACT

Systems and methods for demand-based marketplaces in accordance with embodiments of the invention are disclosed. In one embodiment of the invention, a demand-based marketplace server system includes a processor and a memory storing a demand-based marketplace application, wherein the demand-based marketplace application directs the processor to obtain product demand data, wherein the product demand data includes product keywords describing one or more products, identify product data corresponding to the product demand data, generate lead data based on the product demand data, wherein the lead data is targeted toward one or more seller systems associated with the identified product data, and transmit the lead data to the one or more seller systems.

### CROSS-REFERENCE TO RELATED APPLICATIONS

The present application claims priority to U.S. Provisional Patent Application No. 61/896,428, filed Oct. 28, 2013, the disclosure of which is hereby incorporated by reference in its entirety.

### FIELD OF THE INVENTION

The present invention relates to online marketplaces and more specifically to demand-based marketplace systems.

### BACKGROUND OF THE INVENTION

The term e-commerce is used to refer to the buying and selling of products or services over electronic systems. These electronic systems allow users to communicate with a variety of e-commerce retailers over computer networks such as the Internet. The amount of trade conducted via e-commerce has grown extraordinarily with widespread Internet usage. As a result, varieties of websites operated by e-commerce retailers have been established to offer products and services, such as the Amazon.com service provided by Amazon.com, Inc. of Seattle, Wash. E-commerce websites commonly present each individual product or service available for sale on a separate landing page. Such websites also typically organize the products and/or services offered in a hierarchy and feature categories of products and/or services on separate landing pages.

### SUMMARY OF THE INVENTION

Systems and methods for demand-based marketplaces in accordance with embodiments of the invention are disclosed. In one embodiment of the invention, a demand-based marketplace server system includes a processor and a memory storing a demand-based marketplace application, wherein the demand-based marketplace application directs the processor to obtain product demand data, wherein the product demand data includes product keywords describing one or more products, identify product data corresponding to the product demand data, generate lead data based on the product demand data, wherein the lead data is targeted toward one or more seller systems associated with the identified product data, and transmit the lead data to the one or more seller systems.

In another embodiment of the invention, the product demand data includes category data describing the identified products.

In an additional embodiment of the invention, the memory further stores a taxonomy including categories and attribute-keyword pairs and the demand-based marketplace application further directs the processor to determine the category data by matching a portion of the product keywords with the attribute-keywords pairs in the taxonomy.

In yet another additional embodiment of the invention, the product demand data includes price metadata and the identified product data includes product price data corresponding to the price metadata.

In still another additional embodiment of the invention, the product demand data includes geolocation data and the identified product data is located within the area defined by the geolocation data.

In yet still another additional embodiment of the invention, the lead data is transmitted to a computing device associated with the seller system and the lead data is displayed using the computing device.

In yet another embodiment of the invention, the lead data includes an email.

In still another embodiment of the invention, the lead data includes a small messaging services (SMS) message.

In yet still another embodiment of the invention, the lead data is transmitted via a telephone system.

In yet another additional embodiment of the invention, the demand-based marketplace application further directs the processor to determine compensation metadata associated with the generated lead data, wherein the compensation metadata described a cost associated with the lead data.

In still another additional embodiment of the invention, the demand-based marketplace application further directs the processor to obtain compensation described by the compensation metadata prior to transmitting the lead data.

In yet still another additional embodiment of the invention, the demand-based marketplace application further directs the processor to obtain compensation described by the compensation metadata once a transaction precipitated by the transmitted lead data is completed.

In yet another embodiment of the invention, the transaction is conducted via the demand-based marketplace server system.

In still another embodiment of the invention, cost associated with the lead data is a fixed fee.

In yet still another embodiment of the invention, the cost associated with the lead data is based on price data associated with the product demand data.

In yet another additional embodiment of the invention, the cost associated with the lead data is based on the number of pieces of lead data associated with the seller system.

In still another additional embodiment of the invention, the demand-based marketplace application further directs the processor to determine supply metadata for the identified product data, wherein the supply metadata describes seller systems that have the identified product data in stock and generate lead data based on the determined supply metadata.

In yet still another additional embodiment of the invention, the demand-based marketplace application further directs the processor to identify seller systems having previously stocked products associated with the identified product data, generate notification data describing the demand for the products, and transmit the notification to the seller system.

In yet another embodiment of the invention, a method for demand-based marketplaces includes obtaining product demand data using a demand-based product server system, wherein the product demand data includes product keywords describing one or more products, identifying product data corresponding to the product demand data using the demand-based product server system, generating lead data based on the product demand data using the demand-based product server system, wherein the lead data is targeted toward one or more seller systems associated with the identified product data, and transmitting the lead data to the one or more seller systems using the demand-based product server system.

In still another embodiment of the invention, a non-transitory machine readable medium containing processor instructions, where execution of the instructions by a processor causes the processor to perform a process including obtaining product demand data, wherein the product demand data includes product keywords describing one or more products, identifying product data corresponding to the product demand data, generating lead data based on the product demand data, wherein the lead data is targeted toward one or more seller systems associated with the identified product data, and transmitting the lead data to the one or more seller systems.

### BRIEF DESCRIPTION OF THE DRAWINGS

FIG. 1 is a network diagram of a demand-based marketplace system including interest-driven data visualization systems in accordance with an embodiment of the invention.

FIG. 2 is a conceptual illustration of a demand-based marketplace server system in accordance with an embodiment of the invention.

FIG. 3 is a flowchart illustrating a process for processing product demand data in accordance with an embodiment of the invention.

FIGS. 4A-C are conceptual illustrations of a user interface for creating product demand data in accordance with an embodiment of the invention.

FIG. 4D is a flowchart illustrating a process for creating product demand data in accordance with an embodiment of the invention.

FIG. 5 is a flowchart illustrating a process for providing notifications based on product demand data in accordance with an embodiment of the invention.

FIG. 6 is a flowchart illustrating a process for generating lead data in accordance with an embodiment of the invention.

FIG. 7 is a flowchart illustrating a process for conducting a demand-based transaction via an intermediary service in accordance with an embodiment of the invention.

FIG. 8 is a flowchart illustrating a process for targeting product recommendations within a demand-based marketplace in accordance with an embodiment of the invention.

### DETAILED DISCLOSURE OF THE INVENTION

Turning now to the drawings, systems and methods for demand-based marketplaces in accordance with embodiments of the invention are illustrated. Demand-based marketplaces connect buyers who are interested in purchasing a product and/or service with sellers who can provide the desired product and/or service. Within the demand-based marketplace, buyers provide product demand data identifying the products and/or services that the buyer is interested in purchasing. Likewise, sellers provide product data identifying the products and/or services provided by the seller. The product demand data is matched with product data within the demand-based marketplace and a notification that a potential buyer exists for a given product and/or service can be provided to one or more of the sellers providing the product and/or service. The seller can elect to obtain a lead identifying the buyer matching products and/or services provided by the seller and an overview of the terms the buyer is willing to pay for the product and/or service. A variety of compensation schemes, including those described below, can be utilized to compensate the demand-based marketplace for the provided lead as appropriate to the requirements of specific applications in accordance with embodiments of the invention.

In a variety of embodiments, products and/or services provided within a demand-based marketplace are organized using a taxonomy. The term taxonomy is used to describe a scheme for classifying products and/or services. Within a taxonomy, products, services, or any other good offered via the demand-based marketplace can be defined in terms of categories and attribute-keyword pairs. In this way, a taxonomy can be utilized to categorize products and product demands provided within demand-based marketplaces. In several embodiments, a taxonomy is constructed based upon keywords utilized in the listing of and requests for specific products and/or services that are provided within the demand-based marketplace. The taxonomy can also be used to identify relationships between keyword components used to describe the products and/or services and the categories and attributes within the taxonomy and these relationships used to identify potentially relevant keywords for use in the creation of product demand data and/or product listing data. In a number of embodiments, the possible keywords include known keywords and keywords generated by combining keyword components from known keywords using known grammar patterns.

In a variety of embodiments, demand-based marketplaces are designed to provide an intermediary service (e.g. an escrow service) to facilitate transactions between buyers and sellers. Additionally, demand-based marketplaces can provide targeted advertisements to buyers based on the product demand data provided by the buyers. Targeted advertising is particularly effective within demand-based marketplaces as the buyers are actively providing, via the product demand data, information regarding products that the buyer is looking to purchase. The product data and/or product demand data can also be utilized to provide recommendations to buyers and sellers regarding the availability of particular products at particular price points. That is, a demand-based marketplace can inform a buyer that a product and/or service commonly sells within a particular price range and that outlying values are unlikely to result in the demand-based marketplace identifying products and/or services that the buyer is interested in buying. Similarly, the demand-based marketplace can inform a seller that a particular product and/or service commonly sells for a price within a particular price range and prices exceeding that price range are unlikely to result in a successful lead being generated for that product and/or service. Furthermore, demand-based marketplaces can provide analytical data to buyers and sellers regarding closing rates for the products and/or services provided via the demand-based marketplace. This analytical data includes, but is not limited to, closing rates for leads provided through the demand-based marketplace, conversion rates for leads into sales, successfully fulfilled product requests, and any other analytical data as appropriate to the requirements of specific applications in accordance with embodiments of the invention.

Although the above is described with respect to products and services, it should be noted that demand-based marketplaces in accordance with embodiments of the invention could be utilized to facilitate any transaction. Similarly, the systems and processes described below are not limited to products; services and/or any other transaction can be promoted and exchanged via the demand-based marketplace as appropriate to the requirements of specific applications in accordance with embodiments of the invention. Systems and methods for demand-based marketplace systems in accordance with embodiments of the invention are discussed further below.

### Demand-Based Marketplace System Overview

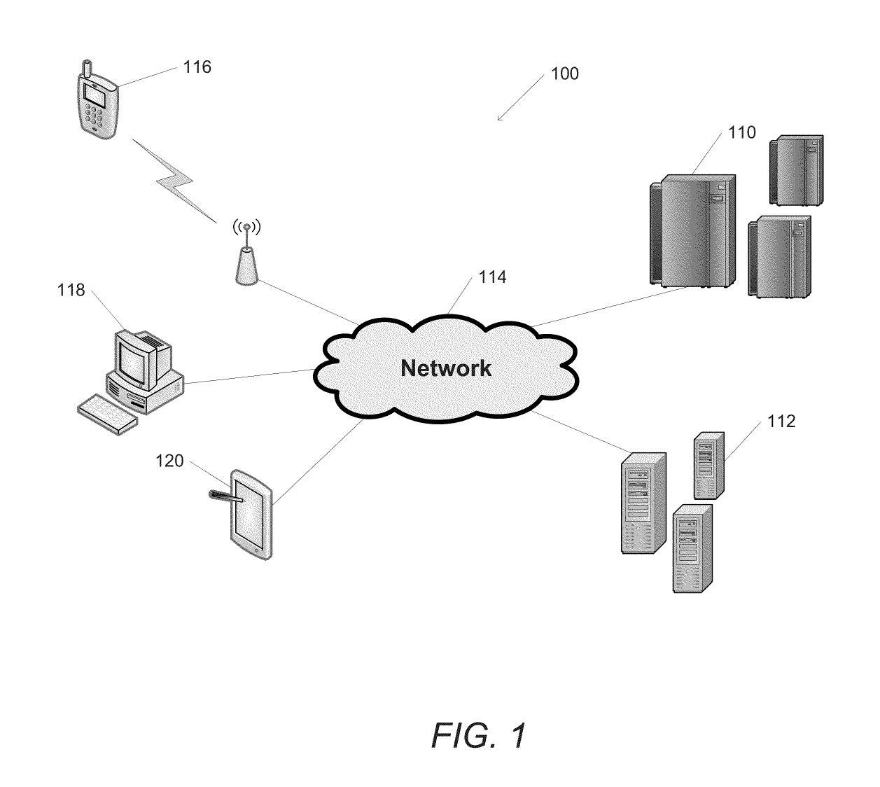

A demand-based marketplace system in accordance with an embodiment of the invention is illustrated in FIG. 1. The demand-based marketplace system 100 includes a demand-based marketplace server system 110 configured to provide a demand-based marketplace service. The demand-based marketplace server system 110 is configured to communicate with seller systems 112 via a network 114. In several embodiments of the invention, the network 114 is a local area network, a wide area network, and/or the Internet; it should be appreciated that any network can be utilized as appropriate to the requirements of specific applications in accordance with embodiments of the invention. The demand-based marketplace server system is also configured to communicate via network 114 with one or more buyer systems, including, but not limited to, mobile devices 116, personal computers 118, and tablets 120. In a variety of embodiments, the seller systems 112 include, but are not limited to, mobile devices, personal computers, and tablets.

The demand-based marketplace server system 110 is configured to provide a demand-based marketplace service to the seller systems 112 and the buyer systems. The seller systems 112 are configured to provide product data describing the products and/or services provided by the seller system 112. The buyer systems are configured to provide product demand data identifying one or more products and/or services that a buyer is interested in acquiring. The demand-based marketplace server system 110 is configured to identify product data associated with one or more seller systems 112 and corresponding to the product demand data obtained from the buyer systems. The demand-based marketplace server system can generate notifications targeted toward seller systems 112 providing products and/or services identified by the product data corresponding to the product demand data. These notifications alert a seller that a potential lead is available. The seller system 112 can then obtain the lead identifying the potential buyer from the demand-based marketplace server system 110. In several embodiments, the seller system 112 provides compensation (e.g. money) to the demand-based marketplace server system 110 in exchange for the provided lead. In many embodiments, the buyer systems provide compensation to the demand-based marketplace server system 110.

In a number of embodiments, the demand-based marketplace server system 110 is configured to provide intermediary services to facilitate the exchange of products and/or services between buyers and sellers. A variety of intermediary services, such as an escrow service, can be provided within the demand-based marketplace service provided by the demand-based marketplace server system 110 as appropriate to the requirements of specific applications in accordance with embodiments of the invention. If available, compensation can be provided by the seller systems 112 and/or the buyer systems to the demand-based marketplace server system 110 based on the transaction conducted via the intermediary service. This intermediary service compensation can be in lieu of or in addition to the compensation related to a lead provided as part of the transaction. Additionally, the demand-based marketplace server system 110 can provide targeted suggestions and/or advertisements to the seller systems 112 and/or the buyer devices based on provided product data and/or product demand data. Advertisements can be provided directly by the demand-based marketplace server system 110 and/or be retrieved from a third-party advertising system and displayed within the demand-based marketplace as appropriate to the requirements of specific applications in accordance with embodiments of the invention. Suggestions related to products and/or services can be provided based on analytical data related to the availability and sales of the products and/or services through the demand-based marketplace service.

Although a specific architecture for a demand-based marketplace system is conceptually illustrated in FIG. 1, any of a variety of architectures, including those where the seller systems and the demand-based marketplace server system are implemented utilizing the same server system, can be utilized in accordance with embodiments of the invention. Systems and methods for demand-based marketplace server systems in accordance with embodiments of the invention are discussed further below.

### Demand-Based Marketplace Server Systems

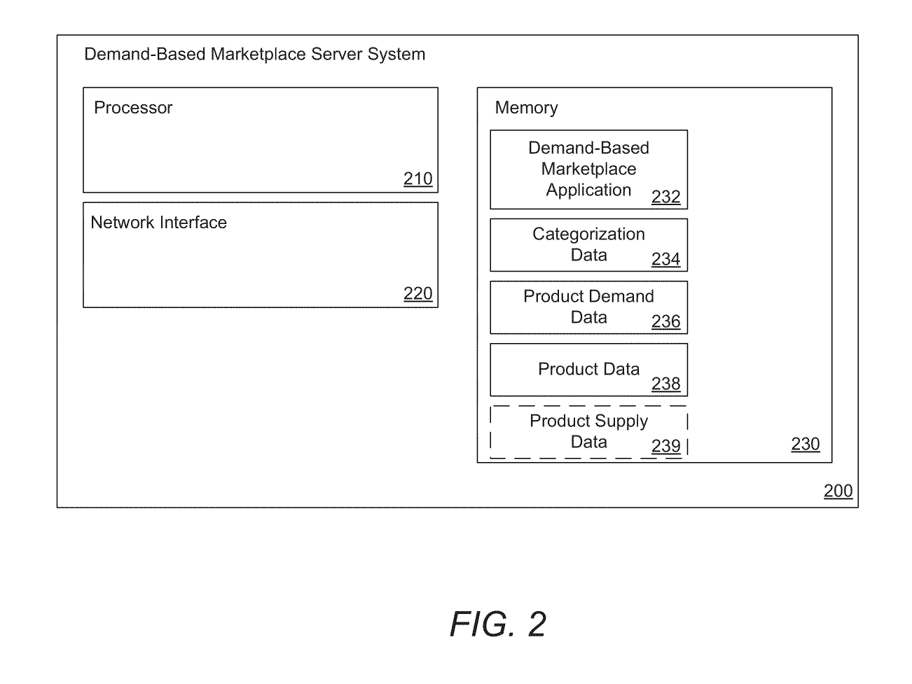

Demand-based marketplace server systems provide demand-based marketplaces to a plurality of buyers and sellers. Demand-based marketplace server systems are configured to identify matches between products requested by buyers and products provided by sellers within the demand-based marketplace and provide the sellers with leads to the buyers. A demand-based marketplace server system in accordance with an embodiment of the invention is conceptually illustrated in FIG. 2. The demand-based marketplace server system 200 includes a processor 210 in communication with a network interface 220 and a memory 230. The network interface 220 is configured to send and receive data over a network connection. In a number of embodiments, the network interface 220 is in communication with the memory 230. In several embodiments, memory 230 is any form of storage configured to store a variety of data, including, but not limited to, a demand-based marketplace application 232, categorization data 234, product demand data 236, product data 238, and/or product supply data 239.

The demand-based marketplace application 232 configures the processor 210 to perform a demand-based marketplace process. The demand-based marketplace process includes obtaining product demand data 236, product data 238, and/or product supply data 239. Product demand data 236 can include, but is not limited to, category metadata identifying one or more categories for the demanded product, brand data and/or model data identifying a particular product, price data, location data identifying the location of the demanded product, condition metadata describing the condition of the demanded product, and user profile data identifying the user (e.g. a buyer system) that desires to acquire the demanded product. Other metadata, such as stock keeping unit (SKU) data, can be included in the product demand data 236 as appropriate to the requirements of specific applications in accordance with embodiments of the invention. User profile data includes, but is not limited to, geolocation information identifying the physical location of the user associated with the user profile data, product demand data and/or product data provided by the user profile, lead data associated with the user profile data, demographic information, and/or any other metadata as appropriate to the requirements of specific applications in accordance with embodiments of the invention. The product data 238 can include, but is not limited to, category metadata identifying one or more categories for the product, brand data and/or model data identifying the product, target price data, location data identifying the location of the product, condition metadata describing the condition of the product, and user profile data identifying the user (e.g. a seller system) that desires to sell the product. Other metadata, such as SKU data, can be included in the product data 238 as appropriate to the requirements of specific applications in accordance with embodiments of the invention. Product supply data 239 can include metadata describing categories for one or more sellers (or product suppliers). Sellers can be associated with a single category or multiple categories as appropriate to the requirements of specific application of embodiments of the invention. Additionally, the product supply data 239 can include demographic information similar to that described above. Furthermore, the product supply data 239 can include performance information describing the product and/or services provided by the seller, buyer satisfaction with the products and/or services provided by the seller, number of leads purchased, leads converted into sales, and any other performance metadata as appropriate to the requirements of specific applications of the invention. Techniques for obtaining product demand data 236, product data 238, and/or product supply data 239 in accordance with embodiments of the invention are described in more detail below.

In a variety of embodiments, the demand-based marketplace process includes identifying one or more categories for the product demand data 236 and/or product data 238 using the categorization data 234. In several embodiments, the categorization data 234 includes a taxonomy, although any data that is utilized to categorize product demand data and/or product data can be used as appropriate to the requirements of specific applications in accordance with embodiments of the invention. In a number of embodiments, the categorization data is global to the product data and product demand data included in the demand-based marketplace. Upon identifying matching product demand data and product data, the demand-based marketplace process includes generating notifications alerting a seller providing a matching product that a potential lead is available. In many embodiments, the demand-based marketplace process involves providing the lead to the seller in exchange for compensation. The compensation is commonly a monetary referral fee, although any form of compensation can be utilized as appropriate to the requirements of specific applications in accordance with embodiments of the invention. The amount of the compensation can be a flat fee and/or variable (e.g. based on the selling price of the product) as appropriate to the requirements of specific applications in accordance with embodiments of the invention. In a number of embodiments, the demand-based marketplace process includes providing intermediary services for completing the transaction between the buyer and the seller. Any of a variety of intermediary services, such as escrow services, can be utilized as part of the demand-based marketplace process as appropriate to the requirements of specific applications in accordance with embodiments of the invention. In several embodiments, the demand-based marketplace application 232 configures the processor 210 to present advertising information (or any product suggestion information) based on the product data 238 and/or the product demand data 236. The provided product information can be based on geolocation information associated with the product data 238 and/or the product demand data 236.

Although a specific architecture for a demand-based marketplace server system in accordance with an embodiment of the invention is conceptually illustrated in FIG. 2, any of a variety of architectures, including those that store data or applications on disk or some other form of storage and are loaded into memory at runtime, can also be utilized. In a variety of embodiments, the memory 220 includes circuitry such as, but not limited to, memory cells constructed using transistors, that are configured to store instructions. Similarly, the processor 210 can include logic gates formed from transistors (or any other device) that are configured to dynamically perform actions based on the instructions stored in the memory. In several embodiments, the instructions are embodied in a configuration of logic gates within the processor to implement and/or perform actions described by the instructions. In this way, the systems and methods described herein can be performed utilizing both general-purpose computing hardware and by single-purpose devices. Processes for demand-based marketplaces in accordance with embodiments of the invention are discussed further below.

### Processing Demand-Based Transactions

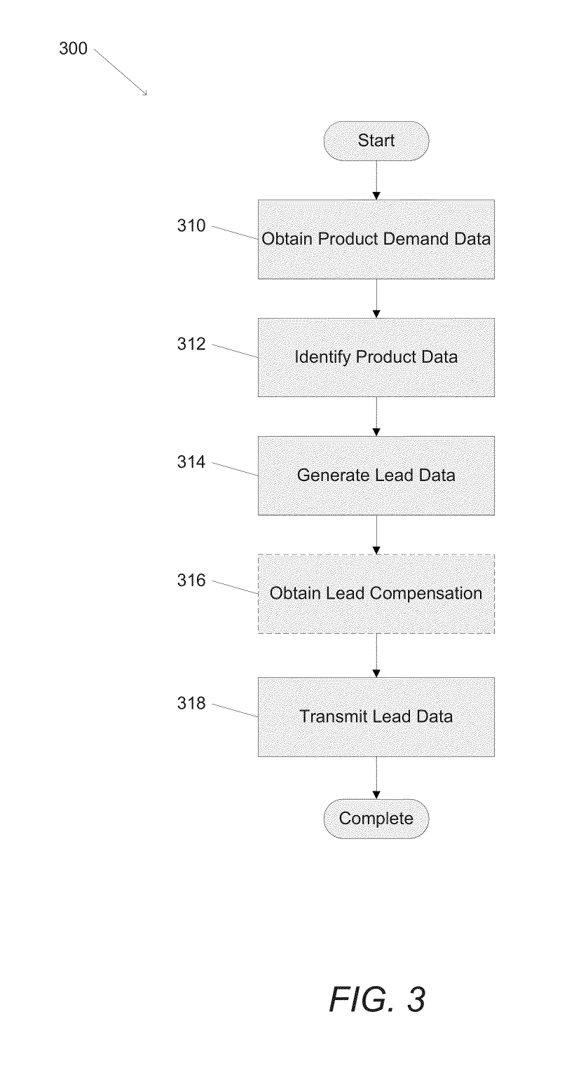

Rather than forcing buyers to peruse a large number of products that may not interest the buyer, demand-based marketplaces provide buyers an opportunity to place a request for a particular item (or category of item) that they wish to purchase. These requests are then matched to products provided by sellers and leads are provided to the sellers so that the buyers and sellers can communicate to complete the transaction. Demand-based marketplace server systems in accordance with embodiments of the invention are configured to provide a demand-based marketplace and process transactions that occur within the marketplace. A process for processing demand-based transactions in accordance with an embodiment of the invention is illustrated in FIG. 3. The process 300 includes obtaining (310) product demand data. Product data is identified (312) and lead data is generated (314). In many embodiments, lead compensation is obtained (316). Lead data is transmitted (318).

In a variety of embodiments, product demand data is obtained (310) from a buyer system associated with a buyer interested in purchasing one or more products identified in the obtained (310) product demand data. In several embodiments, product data is identified (312) based on the obtained (310) product demand data. A variety of techniques can be utilized to identify (312) the product data, including, but not limited to, keyword matching between metadata describing the product data and metadata describing the obtained (310) product demand data, category matching between categories associated with the product data and the demand data, and target price data associated with the product demand data falling within a threshold value of price data associated with the product data. In a number of embodiments, keyword matching and/or category matching is performed using a taxonomy describing the categories and attributes of the product demand data and/or the product data. The keyword matching can include identifying analogous words and/or products (e.g. keyword disambiguation) as appropriate to the requirements of specific applications in accordance with embodiments of the invention.

In many embodiments, the lead data is generated (314) for one or more seller systems associated with the identified (312) product data. The lead data includes, but is not limited to, metadata describing the obtained (310) product demand data and user profile data associated with the obtained (310) product demand data. In a variety of embodiments, a compensation amount is associated with the generated (314) lead data. In a variety of embodiments, the compensation amount is a fixed fee. In a number of embodiments, the compensation amount is variable; this variability can be based on a variety of properties of the transaction, including price data and/or the number of leads purchased by the seller as appropriate to the requirements of specific applications in accordance with embodiments of the invention. In order to obtain the lead data, a seller system provides the compensation amount. As discussed above, a notification can be transmitted that notifies a seller that a potential lead exists. Techniques for generating and transmitting notifications regarding potential leads are described in more detail below. When lead compensation is obtained (316), the lead data is transmitted (318). It should be noted, however, that other compensation schemes, such as compensation for successfully executed leads and/or a flat rate compensation scheme, could be utilized as appropriate to the requirements of specific applications in accordance with embodiments of the invention. In a variety of embodiments, metadata related to the seller's performance in obtaining and converting leads is created utilizing techniques similar to those described herein. Additional techniques for generating lead data that can be utilized in accordance with embodiments of the invention are described below.

Processes for processing demand-based transactions in accordance with embodiments of the invention are discussed above with respect to FIG. 3; however, a variety of processes, including those that obtain lead compensation other than a referral fee, can be utilized in accordance with embodiments of the invention. Techniques for creating and processing product demand data in accordance with embodiments of the invention are described below.

### Creating Product Demand Data

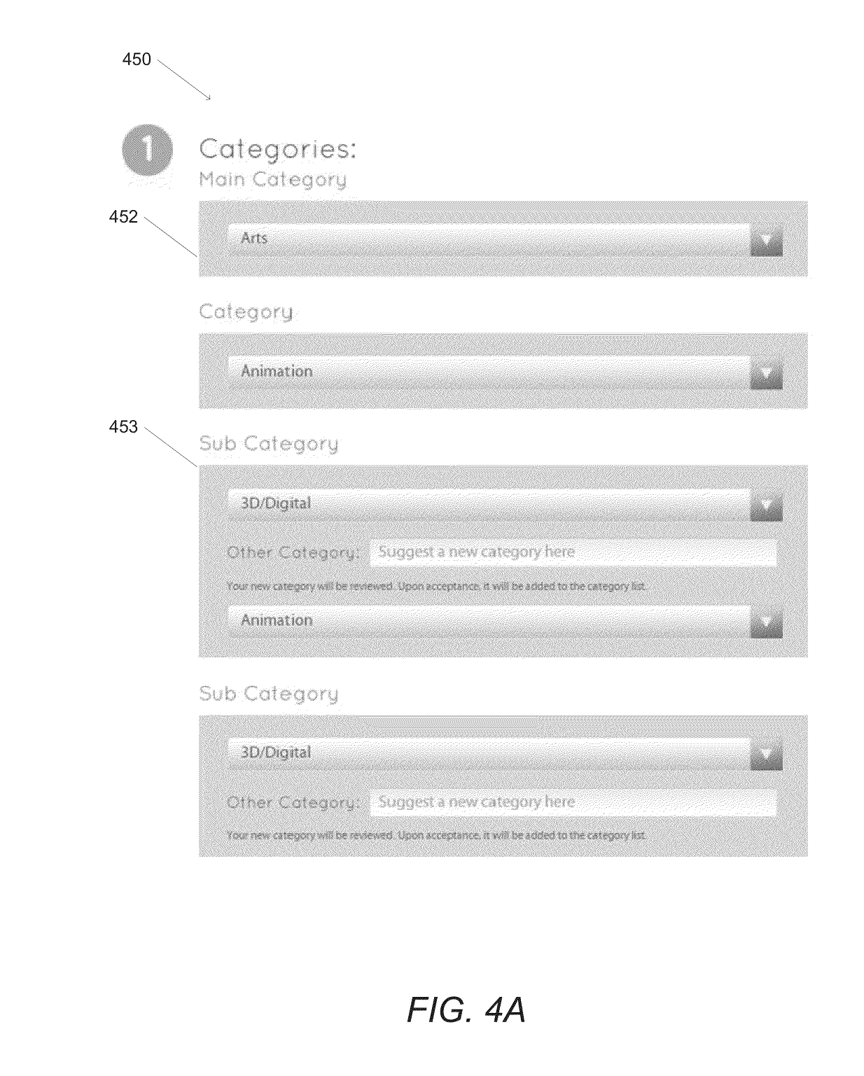

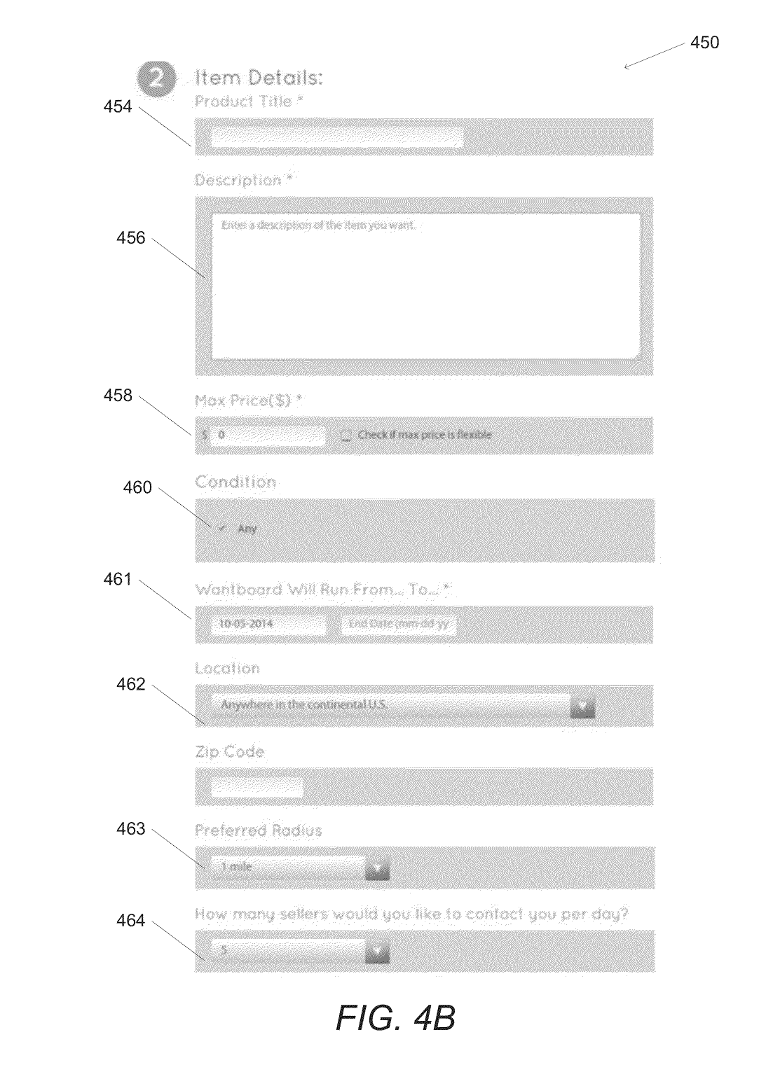

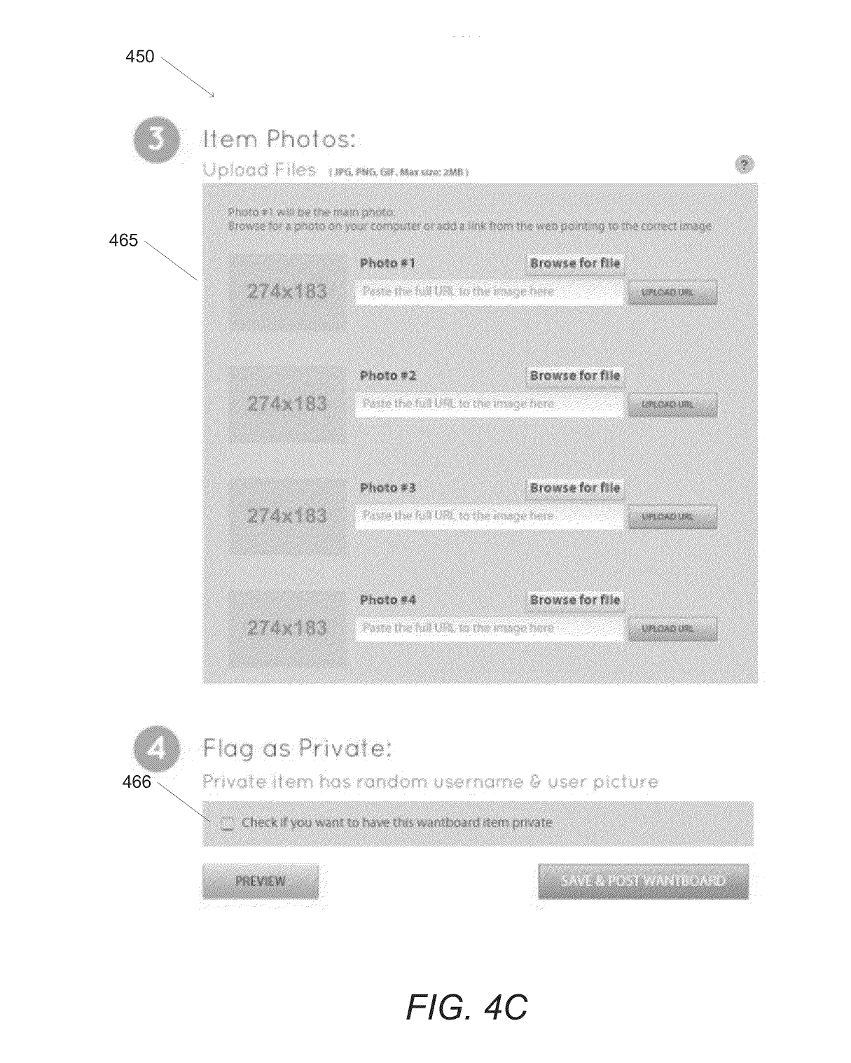

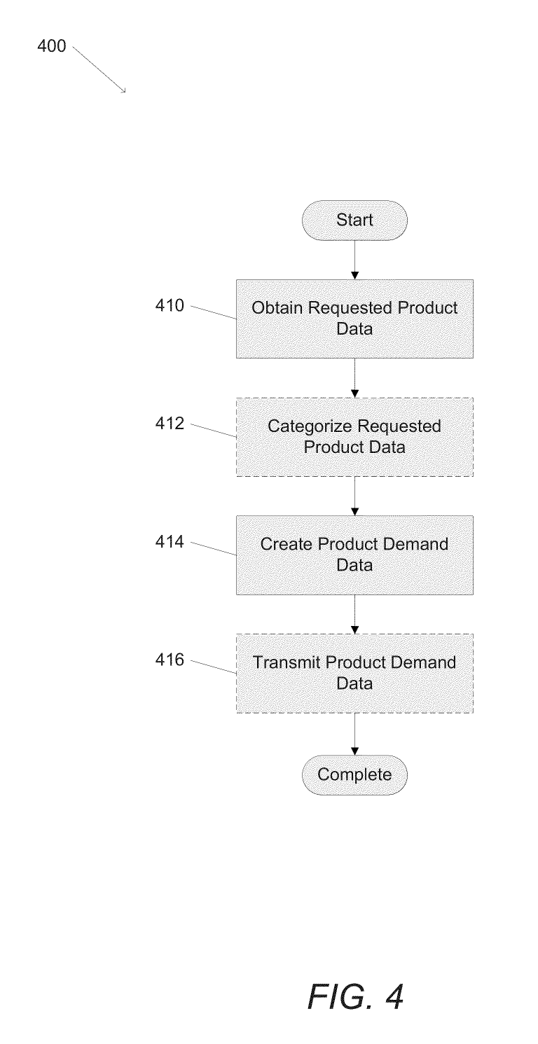

Within demand-based marketplaces, buyers provide data regarding the products they wish to acquire and a price they are willing to pay for the products. Demand-based marketplace server systems are configured to obtain product demand data. In many embodiments, the product demand data is provided by buyer systems associated with a buyer. Turning now to FIGS. 4A-C, conceptual illustrations of a user interface for creating product demand data in accordance with an embodiment of the invention. The user interface 450 includes one or more categories 452 and/or sub-categories 453. The (sub)categories can be provided via the user interface 450 and/or derived from a taxonomy as appropriate to the requirements of specific applications in accordance with embodiments of the invention.

Metadata describing the keywords utilized in identifying product data associated with the notification data includes title keyword data 454 and description keyword data 456. Price data 458 indicates a threshold price for invoking the notification created using the notification data captured via user interface 450. The price data 458 can indicate a minimum price, a maximum price, or any other compensation threshold as appropriate to the requirements of specific applications in accordance with embodiments of the invention. In a variety of embodiments, the price data 458 is recommended and/or influenced based on product data and/or pending product demand data contained within the demand-based marketplace. In this way, the demand-based marketplace server system can provide feedback to sellers regarding the likely price that can be obtained for a particular product and/or service based on the supply and/or demand of the products and/or services. Condition metadata 460 describes the condition of the demanded product data. For example, a consumer that is only interested in new products can be interested in a like new product provided by a seller, but may not be interested in a product in not working condition. A variety of conditions, including new, refurbished, used, and for parts, can be described within the condition metadata. It should be noted that any condition can be described within the condition metadata as appropriate to the requirements of specific applications in accordance with embodiments of the invention. Time frame data 461 for the product demand data can be defined. This time frame data can be open-ended (in that it has a start date but no end date) and include any combination of days, months, years, hours, minutes, and/or seconds as appropriate to the requirements of specific applications of embodiments of the invention. Location data 462 can be defined. Location data includes, but is not limited to, a specific zip code, city, state, street, address, intersection, geographic coordinates, a radius from any arbitrary point, and any other measure of location (or region of locations) as appropriate to the requirements of specific applications of the invention. A maximum limit of sellers 464 can also be defined. In this way, buyers can receive offers from highly rated sellers and/or avoid being overwhelmed with response to the product demand data. Image data 465 can also be associated with the product demand data; however, any metadata including, but not limited to, audio data, video data, and links to third-party content sites can also be utilized as appropriate to the requirements of specific applications of the invention. Product demand data can also be flagged as private 466. Private demand data that has been marked as private can include a randomized user name, picture, or any other metadata that obfuscates the identity of the buyer as appropriate to the requirements of specific applications of embodiments of the invention.

A process for creating product demand data in accordance with an embodiment of the invention is illustrated in FIG. 4D. The process 400 includes obtaining (410) product data and, in a variety of embodiments, categorizing (412) product data. Product demand data is created (414) and product demand data is transmitted (416). In many embodiments, requested product data is obtained (410) as input using a buyer system. The requested product data includes metadata describing the properties of a desired product, such as brand information, model information, technical capabilities, geographic location information of the product, and/or any other metadata as appropriate to the requirements of specific applications in accordance with embodiments of the invention. The obtained (410) requested product data can be based on product demand data and/or product data having geolocation data within a threshold distance of the geographic location of the requested product data. In a number of embodiments, the obtained (410) requested product data includes category metadata describing one or more categories associated with the requested product data. In several embodiments, the category metadata is utilized to categorize (412) the requested product data. In a variety of embodiments, a taxonomy is utilized to categorize (412) the requested product data based on the metadata contained within the obtained (410) requested product data and the categories and attributes contained within the taxonomy. Product demand data is created (414) based on the requested product data and/or the categories used to categorize (412) the requested product data as appropriate to the requirements of specific applications in accordance with embodiments of the invention. In several embodiments, the created (414) product demand data includes price data indicating a threshold value for the price of the desired product. In a number of embodiments, the price data is based on other distinct pieces of product demand data for the obtained (410) requested product data and/or separate (requested) product data identified as similar (e.g. within the same category or a related category) to the obtained (410) requested product data. The price data in the requested (410) product demand data can be fixed or be flexible within a range of prices. In this way, the product demand data can include price data that is likely to result in a lead being generated based on the product demand data. In many embodiments, the product demand data is transmitted (416) to a demand-based marketplace server system.

Although specific interfaces and processes for creating product demand data in accordance with embodiments of the invention are discussed above with respect to FIGS. 4A-D, a variety of processes, including those that contain additional product demand data not specifically described above, can be utilized in accordance with embodiments of the invention. Processes for processing product demand data within demand-based marketplaces in accordance with embodiments of the invention are described below.

Providing Notifications within Demand-Based Marketplaces

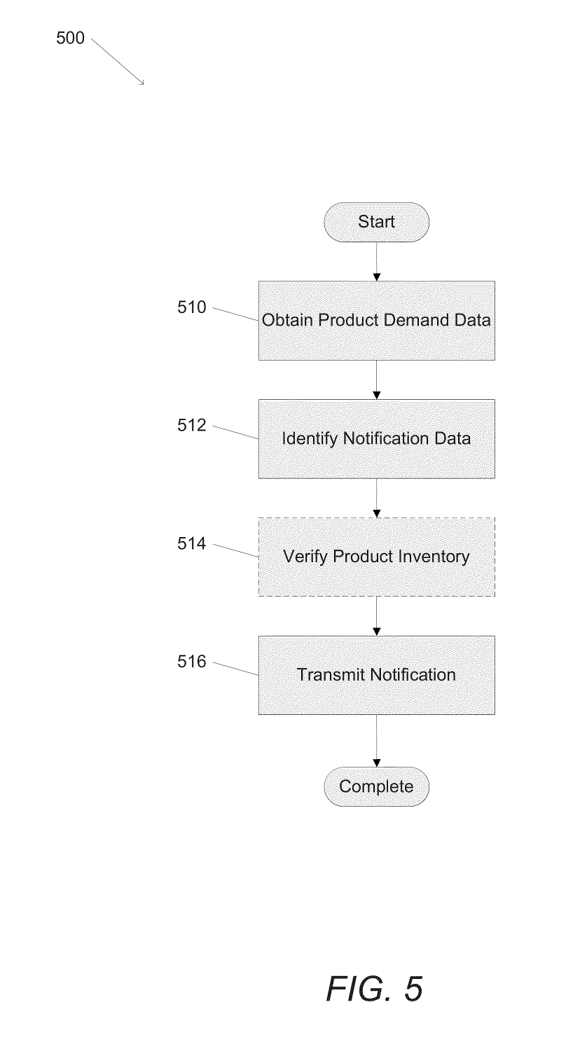

Within a demand-based marketplace, sellers provide data describing products and/or services provided by the seller. When buyers indicate that they are interested in purchasing products that can be provided by the seller, the demand-based marketplace can provide one or more notifications to sellers that a potential buyer for their products has been identified. Demand-based marketplace server systems in accordance with embodiments of the invention are configured to provide notifications regarding potential leads to sellers within the demand-based marketplace. A process for providing notifications within a demand-based marketplace in accordance with an embodiment of the invention is illustrated in FIG. 5. The process 500 includes obtaining (510) product demand data. Notification data is identified (512) and, in several embodiments, product inventory is verified (514). Notifications are transmitted (516). In a number of embodiments, product demand data is obtained (510) using processes similar to those described above. In many embodiments, notification data is identified (512) based on the products and/or categories included in the obtained (510) product demand data. In a variety of embodiments, the notification data is identified (512) based on geolocation data indicating that the seller is located within a threshold distance from the buyer identified in the obtained (510) product demand data. Notification data includes a variety of metadata including user profile data describing the seller system (e.g. the seller) that provides a product and/or service associated with the obtained (510) product demand data. Additional metadata that can be included within the identified (512) notification data as appropriate to the requirements of specific applications in accordance with embodiments of the invention is described above with respect to FIGS. 4B-D. In a variety of embodiments, an identified (512) piece of notification data includes metadata describing the quantity of products available to fulfill the obtained (510) product demand data. If available, the inventory of product associated with the notification data can be verified (514). By verifying (514) that product inventory exists, demand-based marketplace server systems can avoid sending unnecessary notifications to seller systems. Additionally, demand-based marketplace server systems can verify (514) a product inventory level and provide a notification to a seller system that demand exceeding the inventory level established by the seller exists for one or more products provided by the seller. In this way, the demand-based marketplace server system can provide guidance to sellers regarding products and/or services that the seller could provide. In a number of embodiments, a notification is transmitted (516) to the seller system (e.g. the seller) associated with the identified (512) notification data. Notifications can be transmitted (516) in a variety of way as appropriate to the requirements of specific applications in accordance with embodiments of the invention, including, but not limited to, email, small messaging services (SMS), really simple syndication (RSS) feeds, fax, telephone calls, pop-up message (i.e. alert), push notifications (i.e. notifications presented by one or more devices associated with a buyer and/or seller), physical mail, online social networks, and any other third-party system.

Processes for creating product data and providing notifications within demand-based marketplaces in accordance with embodiments of the invention are discussed above with respect to FIG. 5; however, a variety of processes and interfaces can be utilized in accordance with embodiments of the invention. Techniques for generating lead data and promoting products in accordance with embodiments of the invention are discussed below.

### Generating Lead Data

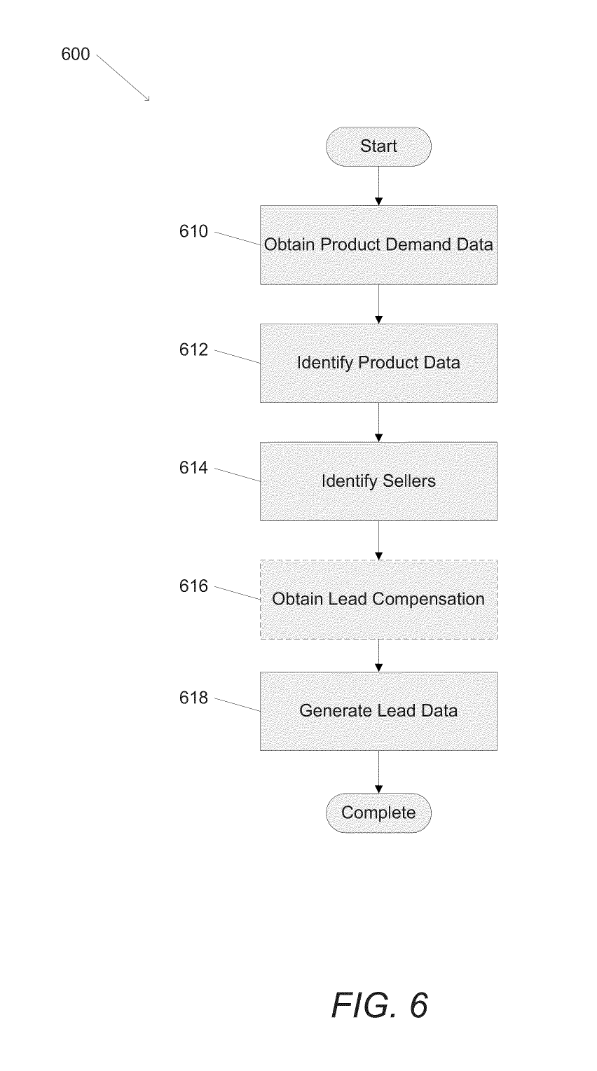

As discussed above, demand-based marketplaces provide leads to sellers indicating that one or more buyers are interested in procuring products and/or services provided by the sellers. Demand-based marketplace server systems are configured to generate lead data. A process for generating lead data in accordance with an embodiment of the invention is illustrated in FIG. 6. The process 600 includes obtaining (610) product demand data and identifying (612) product data. Sellers are identified (614) and, in a number of embodiments, lead compensation is obtained (616). Lead data is generated (618).

In a number of embodiments, product demand data is obtained (610) utilizing processes similar to those described above. In several embodiments, product data is identified (612) utilizing processes similar to those described above. In a variety of embodiments, sellers are identified (614) based on the identified (612) product data. In many embodiments, sellers are identified (614) based on notification data generated based on the obtained (610) product demand data and/or identified (612) product data. In several embodiments, sellers are identified (614) based on geolocation information indicating that a seller is located within a threshold distance of the buyer indicated by the obtained (610) product demand data. In several embodiments, the product demand data includes a particular number of sellers that may contact the buyer and identifying (614) sellers includes selecting not more than the buyer-defined number of sellers. In a variety of embodiments, identifying (614) sellers includes calculating a confidence score based on the likelihood that a seller will be able to close a deal with the buyer. In many embodiments, identifying (614) sellers includes modifying the obtained (610) product demand data based on the identified (612) product data. For example, if a buyer has specified a particular product (e.g. a home) at a particular price that does not exist in the buyer's desired location, sellers can be identified (614) that are selling homes in the desired area at a higher price and/or selling homes at the desired price in nearby locations.

In a number of embodiments, lead compensation is obtained (616) utilizing processes similar to those described above. A variety of data can be included in the generated (618) lead data, such as user profile data identifying the buyer associated with the obtained (610) product demand data, metadata describing the condition and/or properties of the product, location information, and price data describing the price the buyer is willing to spend on the product, as appropriate to the requirements of specific applications in accordance with embodiments of the invention. In several embodiments, the generated (618) lead data includes compensation metadata describing a cost associated with the acquisition of and/or the user of the generated (618) lead data.

Processes for generating lead data in accordance with embodiments of the invention are discussed above with respect to FIG. 6; however, a variety of processes, including those that generate multiple leads and/or provide leads to multiple sellers, can be utilized in accordance with embodiments of the invention. Techniques for conducting demand-based transactions within a demand-based marketplace in accordance with embodiments of the invention are described below.

### Conducting Demand-Based Transactions

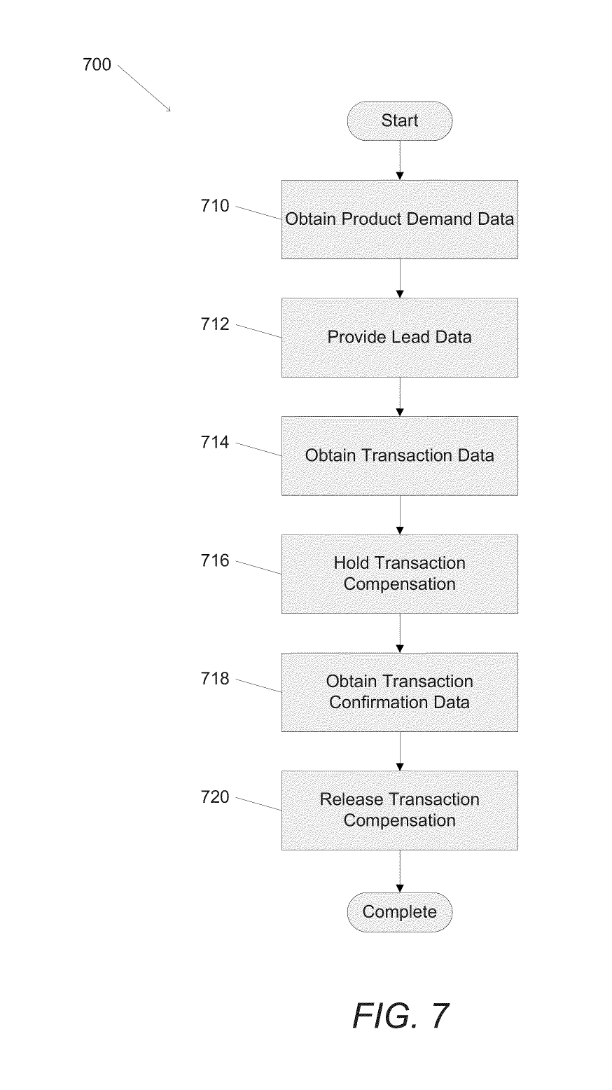

Many demand-based marketplaces provide intermediary services for not only the generation of leads, but for facilitating the exchange of products and/or services and the associated compensation between the buyer and the seller. In this way, a demand-based marketplace can be a unified service for the location and acquisition of products and/or services. Demand-based marketplace server systems in accordance with embodiments of the invention are configured to facilitate the exchange of products and compensation between buyers and sellers. A process for conducting demand-based transactions in accordance with an embodiment of the invention is illustrated in FIG. 7. The process 700 includes obtaining (710) product demand data. Lead data is provided (712) and transaction data is obtained (714). Transaction compensation is held (716). Transaction confirmation data is obtained (718) and transaction compensation is released (720).

In several embodiments, product demand data is obtained (710) utilizing processes similar to those described above. In a number of embodiments, lead data is provided (712) utilizing processes similar to those described above. The obtained (714) can include a variety of data, including buyer user profile data identifying a buyer, seller user profile data identifying a seller, and/or lead data indicating the lead that was utilized in obtaining (714) the transaction data. In many embodiments, the transaction data is obtained (714) from a buyer system indicating that a buyer is proceeding to acquire product(s) and/or service(s) from a seller. In a variety of embodiments, the transaction data is obtained (714) from a seller system indicating that a seller is intending to provide product(s) and/or service(s) to a buyer. In several embodiments, the transaction data includes compensation metadata describing the terms associated with the compensation to be provided to the seller. In a variety of embodiments, the compensation metadata describes the products and/or services to be provided to the buyer. The compensation is transmitted to and held (716) by the demand-based marketplace server system. Additionally, the products and/or services to be provided by the seller can also be transmitted to the demand-based marketplace as appropriate to the requirements of specific applications in accordance with embodiments of the invention. In this way, the demand-based marketplace provides an escrow service between buyers and sellers. In a number of embodiments, transaction confirmation data is obtained (718) from the buyer system and/or the seller system when the products and/or services have been shipped to and/or received by the buyer. In several embodiments, the held (716) transaction compensation is released (720) once the transaction confirmation data is obtained (718). In a variety of embodiments, the transaction compensation is released (720) when the products and/or services are acquired by the demand-based marketplace; the demand-based marketplace then forwards the products and/or services to the buyer and the compensation to the seller. In a number of embodiments, the released (720) transaction compensation includes an amount deducted for providing the escrow service and/or providing the lead data.

Although specific processes for conducting demand-based transactions in accordance with embodiments of the invention are discussed above with respect to FIG. 7, a variety of processes, including those that utilize alternative techniques for monetizing the transaction conducted within the demand-based marketplace, can be utilized in accordance with embodiments of the invention. Processes for recommending products and/or services within demand-based marketplaces in accordance with embodiments of the invention are detailed below.

Product Recommendations within Demand-Based Marketplaces

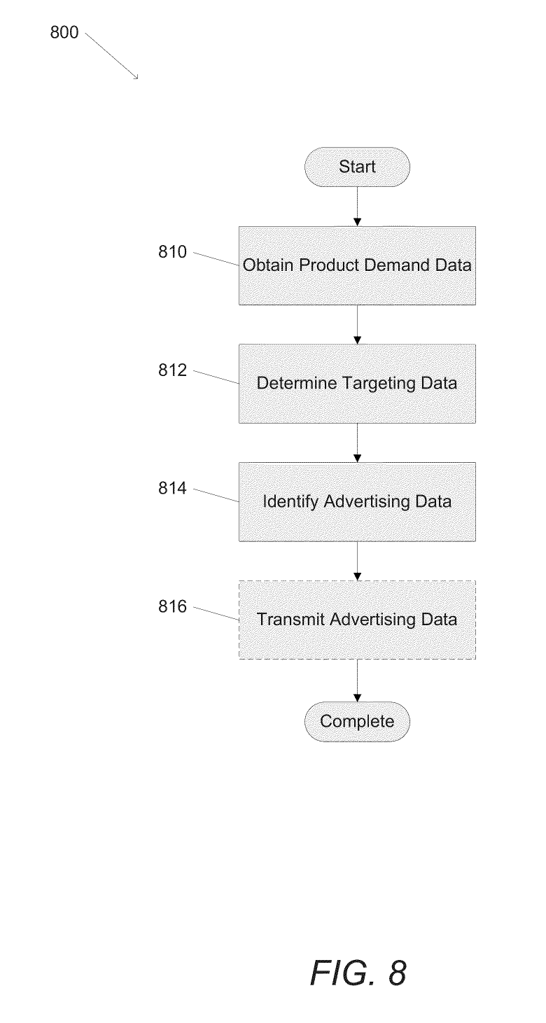

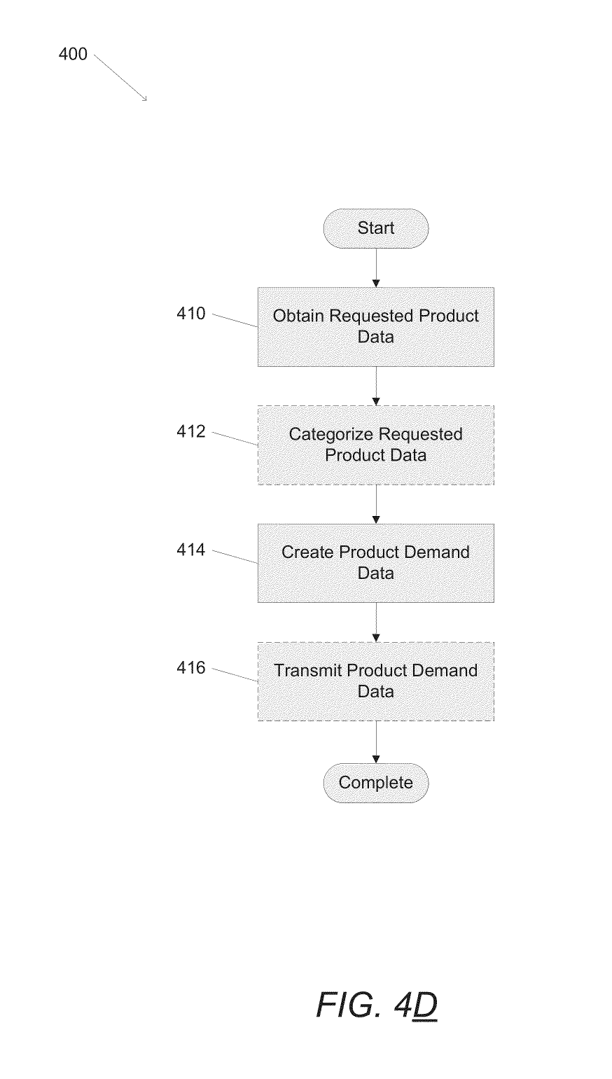

Product recommendations, in particular advertising, are widely utilized to promote products and/or services that can be of interest to a user. Within a demand-based marketplace, products and/or services can be targeted with a high degree of precision due to the nature of the demand-based marketplace. Most notably, buyers within a demand-based marketplace directly specify the parameters of products and/or services that the buyer is actively looking to purchase. Similarly, products can be targeted toward sellers based on the performance of those products within the demand-based marketplace. Demand-based marketplace server systems in accordance with embodiments of the invention are configured to target advertising based on received product data and/or product demand data. A process for advertising within demand-based marketplaces in accordance with an embodiment of the invention is illustrated in FIG. 8. The process 800 includes obtaining (810) product demand data and determining (812) targeting data. Advertising data is identified (814) and, in several embodiments, advertising data is transmitted (816).

In many embodiments, product demand data is obtained (810) utilizing processes similar to those described above. In a variety of embodiments, targeting data is determined (812) based on the keywords, categories, and/or price data contained within the obtained (810) product demand data. In several embodiments, targeting data is determined (812) based on geolocation information associated with the product demand data, e.g. the location of the buyer looking for a particular product and/or service within the demand-based marketplace. Advertising data is identified (814) based on the targeting data and/or the product demand data as appropriate to the requirements of specific applications in accordance with embodiments of the invention. In a number of embodiments, advertising data is identified (814) based on advertising data previously associated with user profile data included in the obtained (810) product demand data. In several embodiments, advertising data is transmitted (816) to the device from which the product demand data was obtained (810). In a number of embodiments, the advertising data is transmitted (816) from a third-party advertising system based on the determined (812) targeting data and/or identified (814) advertising data. In a variety of embodiments, the advertising data describes products that are available via the demand-based marketplace.

Processes for providing targeted advertising data in accordance with embodiments of the invention are discussed above with respect to FIG. 8; however, a variety of processes, including those that provide advertisements stored on external advertising server systems and processes that provide recommendations other than advertisements can be utilized in accordance with embodiments of the invention.

Although the present invention has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present invention can be practiced otherwise than specifically described without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

1. A demand-based marketplace server system, comprising:
a processor; and
a memory storing a demand-based marketplace application;
wherein the demand-based marketplace application directs the processor to:
obtain product demand data, wherein the product demand data comprises product keywords describing one or more products;
identify product data corresponding to the product demand data;
determine supply metadata for the identified product data, wherein the supply metadata describes seller systems that have the identified product data in stock;
generate lead data based on the product demand data and the determined supply metadata, wherein the lead data is targeted toward one or more seller systems associated with the identified product data; and
transmit the lead data to the one or more seller systems identified using the determined supply metadata.

2. The system of claim 1, wherein the product demand data comprises category data describing the identified products.

3. The system of claim 2, wherein:
the memory further stores a taxonomy comprising categories and attribute-keyword pairs; and
the demand-based marketplace application further directs the processor to determine the category data by matching a portion of the product keywords with the attribute-keywords pairs in the taxonomy.

4. The system of claim 1, wherein:
the product demand data comprises price metadata; and
the identified product data comprises product price data corresponding to the price metadata.

5. The system of claim 1, wherein:
the product demand data comprises geolocation data; and
the identified product data is located within the area defined by the geolocation data.

6. The system of claim 1, wherein:
the lead data is transmitted to a computing device associated with the seller system; and
the lead data is displayed using the computing device.

7. The system of claim 6, wherein the lead data comprises an email.

8. The system of claim 6, wherein the lead data comprises a small messaging services (SMS) message.

9. The system of claim 1, wherein the lead data is transmitted via a telephone system.

10. The system of claim 1, wherein the demand-based marketplace application further directs the processor to determine compensation metadata associated with the generated lead data, wherein the compensation metadata described a cost associated with the lead data.

11. The system of claim 10, wherein the demand-based marketplace application further directs the processor to obtain compensation described by the compensation metadata prior to transmitting the lead data.

12. The system of claim 10, wherein the demand-based marketplace application further directs the processor to obtain compensation described by the compensation metadata once a transaction precipitated by the transmitted lead data is completed.

13. The system of claim 12, wherein the transaction is conducted via the demand-based marketplace server system.

14. The system of claim 10, wherein the cost associated with the lead data is a fixed fee.

15. The system of claim 10, wherein the cost associated with the lead data is based on price data associated with the product demand data.

16. The system of claim 10, wherein the cost associated with the lead data is based on the number of pieces of lead data associated with the seller system.

17. (canceled)

18. The system of claim 1, wherein the demand-based marketplace application further directs the processor to:
identify seller systems having previously stocked products associated with the identified product data;
generate notification data describing the demand for the products; and
transmit the notification to the seller system.

19. A method for demand-based marketplaces, comprising:
obtaining product demand data using a demand-based product server system, wherein the product demand data comprises product keywords describing one or more products;
identifying product data corresponding to the product demand data using the demand-based product server system;
determining supply metadata for the identified product data using the demand-based product server system, wherein the supply metadata describes seller systems that have the identified product data in stock;
generating lead data based on the product demand data and the determined supply metadata using the demand-based product server system, wherein the lead data is targeted toward one or more seller systems associated with the identified product data; and
transmitting the lead data to the one or more seller systems identified using the determined supply metadata using the demand-based product server system.

20. A non-transitory machine readable medium containing processor instructions, where execution of the instructions by a processor causes the processor to perform a process comprising:
obtaining product demand data, wherein the product demand data comprises product keywords describing one or more products;
identifying product data corresponding to the product demand data;
determining supply metadata for the identified product data, wherein the supply metadata describes seller systems that have the identified product data in stock;
generating lead data based on the product demand data and the determined supply metadata, wherein the lead data is targeted toward one or more seller systems associated with the identified product data; and
transmitting the lead data to the one or more seller systems identified using the determined supply metadata.
